(19) United States
(12) Patent Application Publication
(10) Pub. No.: US 2004/0254832 A1
(43) Pub. Date: Dec. 16, 2004

(54) Integrated browser plug-in and user defined database

(76) Inventor: Michael Harkin, Roslyn, NY (US)

Correspondence Address: WILLIAM COLLARD, COLLARD & ROE, P.C., 1077 NORTHERN BOULEVARD, ROSLYN, NY, 11576, US

(21) Appl. No.: 10/459,990

(22) Filed: Jun. 12, 2003

(51) Int. Cl. G06F 17/60; G06F 15/16; G06F 7/00; G06F 17/30

(52) U.S. Cl. 705/14; 709/203; 707/10

(57) ABSTRACT

A multi-tier computer application that utilizes a web browser and a web server. The computer application includes a browser plug-in that runs simultaneously with the web browser and receives URL information from the web browser. This plug-in then sends requests and receives responses from the web server. A central database and a plug-in server run on the web server. A web site also runs on the web server. Web related information and user information is sent as a request from the browser plug-in to the web server and then routed through the web server to the plug-in server. The plug-in server then queries for feedback in the central database relating to the request. Feedback results are transmitted from the plug-in server through the web server to the browser plug-in and a visualization is transmitted from the browser plug-in to the web browser.

### BACKGROUND OF THE INVENTION

The invention relates to a multi-tier computer application that provides users with a way to interact, vote, and form constituency groups and cooperatives in order to actualize, solutions to business, commerce, education government labor, media, etc. The networked exchange will allow members to find goods and service providers and find commonality between members and groups.

The system involves a browser plug-in that is integrated into the browsers structure. This plug-in provides the link to the network and central database.

U.S. Patent Application Publication No. US 2002/0123912 A1 to Subramanian incorporated herein by reference discloses an Internet contextual communication system. U.S. Pat. No. 6,442,590 to Inala et al incorporated herein by reference discloses a method and apparatus for a site insensitive interactive chat network.

The present invention differs from these references in that users of the system are included in a forum that provides user posts, feedback or media that can be associated with a particular website. Further a browser plug-in is activated to provide access to the forum, bulletin board or discussion group.

### SUMMARY OF THE INVENTION

The present invention relates to a multi-tier computer application that utilizes a web browser and a web server along with a plug-in program into the web browser. The web server receives HTTP requests from and sends web content to the web browser. The computer application includes a browser plug-in that runs simultaneously with the web browser wherein it receives and links to URL information from the web browser such that the activity and information of the plug in is linked to the web page being shown in the browser. This plug-in then sends requests and receives responses from the web server. A central database is in communication with the web server and stores, manages, queries, and manipulates data. A plug-in server runs on the web server, is routed URL information from the web server, and begins a query relating to the IP/Host name then sends the result back through the web server to the browser plug-in. A web site associated with the plug-in program runs on the web server, and registers users, changes a user's profile and provides broadcast media so that once users are registered via the website, they can use the plug in, in a manner such that it is linked personally to them.

Once the user is registered, the plug-in is installed on the web browser. Now, the user can request a web-page in a standard manner such that the user posts a HTTP request in the form of a URL address wherein this HTTP request is sent from the web browser to the web server. Web content is then sent from the web server to the web browser in response to the HTTP requests. Web related information and user information is sent as a request from the browser plug-in to the plug-in server. The plug-in server requests or queries to see whether that particular website is registered or has any associations or any associated additional information stored in the plug-in database. When the plug in receives recognition that there is a link, the plug-in flashes or raises another form of indication such as a beep to let the user know that the present site has additional associated information that is linked. Upon clicking the associated plug-in button the user is exposed to an array of options such as selecting an associated feedback link. The plug-in server then queries for feedback in the central database relating to the request. Feedback results are transmitted from the plug-in server through the web server to the browser plug-in and a visualization is transmitted from the browser plug-in to the web browser. With this design, the server then controls the plug-in program to provide additional functionality in the form of an additional screen to provide a forum for discussions, reviews, or searching based upon the first screen.

### BRIEF DESCRIPTION OF THE DRAWINGS

Other objects and features of the present invention will become apparent from the following detailed description considered in connection with the accompanying drawings. It is to be understood, however, that the drawings are designed as illustrations only and not as definitions of the limits of the invention.

FIG. 1 shows a flow chart of the multi-tier application;

FIG. 2 shows a flow chart of the different tables of the central database;

FIG. 3 shows a flow chart of the services provided by the application;

FIG. 4a shows a first method of communication in the application;

FIG. 4b shows a second method of communication in the application;

FIG. 4c shows a third method of communication in the application;

FIG. 4d shows a fourth method of communication in the application;

FIG. 5 shows a user tree structure for database use;

FIG. 6a shows a view of a web browser with a plug in button according to the invention;

FIG. 6b shows a view of the web browser of 6a with the plug-in activated;

FIG. 7 is a view of a first embodiment of the activated screen;

FIG. 8 is a view of the second embodiment of the activated screen; and

FIG. 9 is a view of the third embodiment of the activated screen.

### DETAILED DESCRIPTION OF THE PREFERRED EMBODIMENT

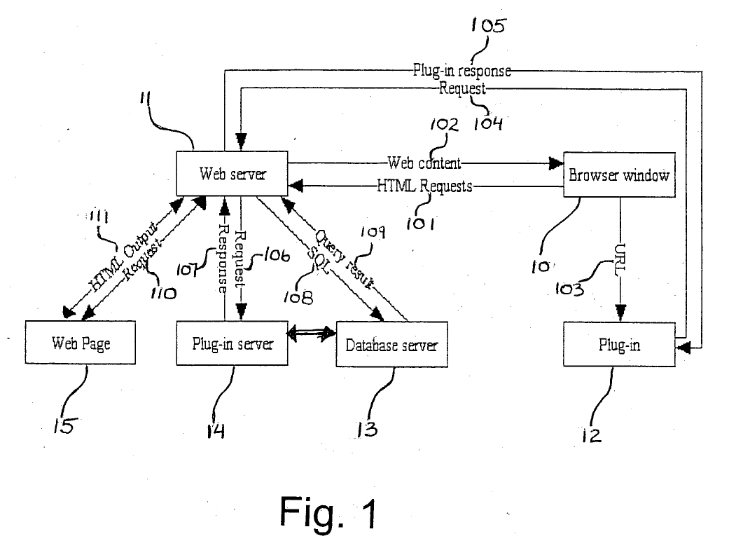

Referring in detail to the drawings, FIG. 1 shows a schematic block diagram showing the hardware components and the flow of information between these components for the multi-tier application. The multi-tier computer application utilizes a web browser 10 and a web server 11. In normal application, web browser 10 sends HTTP requests to web server 11 and web server 11 then sends web content to web browser 10. The computer application of the present invention comprises a browser plug-in 12 that runs with and is integrated into web browser 10. Browser plug-in 12 can receive URL information from web browser 10 and send requests to, and receive responses from web server 11.

A central database server 13 in communication with web server 11, stores, manages, queries and manipulates data relating to the computer application. A plug-in server 14 runs on web server 11 and is routed URL information from web browser 10 and queries central database 13 relating to plug-in 12 requests. Plug-in server 14 then sends results back through web server 11 to browser plug-in 12 or sends results directly to browser plug-in 12. Finally, a web site or web page 15 runs on web server 11 along with an additional base web site 115. Web site 15 registers users, changes user profiles, and broadcasts media for the plug-in application.

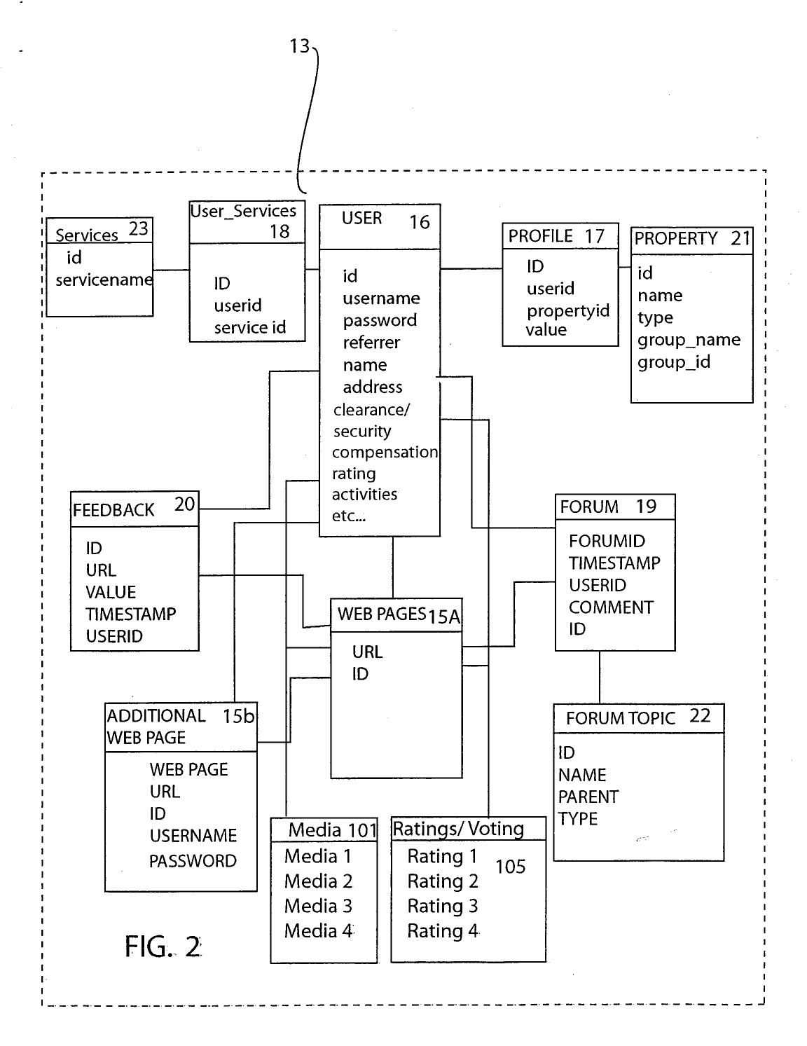

FIG. 2 shows a block diagram of the different tables which are used in transferring information between the different tables of central database 13. A user information table 16 comprises an identification (id), a user name, a password, a referrer name, an address, clearance/security information, a compensation field and a rating field. Each user information table 16 is associated with at least one member profile table 17 comprising an id, a user id, a property id, and a value. Every member profile table 17 has a property table 21. Property table 21 stores information relating to a users likes and dislikes and contains an id, name, type, group name, and group id.

The user information table 16 is linked to at least one forum table 19. Forum table 19 establishes a forum set up having messages and topics. Specifically forum table 19 comprises an id, a forum id, a time stamp, a user id, and a comment. Every forum table 19 has a forum topic table 22 comprising an id, a name, a parent, and a type.

Associated with each user information table 16 is at least one feedback table 20 comprising an id, a URL, a value, a timestamp, and a user id. Feedback table 20 permits users to send feedback regarding a URL and browser plug-in 12 to display other users feedback regarding that URL.

Each user information table 16 is associated with at least one user services table 18 comprising an id, a user id, and a service id. Every user services table 18 has a services table 23 comprising an id and a service name. There is also a web-pages table 15a that carries a listing of all URL addresses and an associated ID which corresponds to the id in table 16. This listing is for all registered web-sites that have associated information. Thus, if the user opens an associated web page that has a URL address listed that is registered the plug-in button 12′ of plug in 12 starts flashing (see FIG. 6A). There is also an additional web page table 15b such that the clearance field associated with table 16 controls the user's access to the information associated with the web pages.

There is also a media table 101 which is linked to user information table 16 wherein media table. 101 provides a listing of all of the specialized media files associated with that user and also associated with that primary, first or base website. In addition there is also a ratings or voting table 105 that is associated with both web page table 15a and user identification table 16.

With tables 15b, 19, 20, 22, 101, and 105 all of them have specialized information that is related to either the user's identification or ID in table 16, or the opened primary web page URL address in table 15a.

With this system, there is an ability for each opened website to have specialized linked information associated with tables 15b, 19, 20, 22, 101, and 105 and also the ability for users to control another user's access to this specialized information.

The process for controlling these users is as follows:

Once a user registers, primary users, or users which are of majority age receive a default setting allowing users open access to any set of linked information associated with one of the above tables. However, if that user or member misbehaves, other users can submit a complaint about that user and a central governing body made up of users will vote to either release the user from any charge, restrict the user's access to content or fine that user, or expel the user entirely from the program. The verdict on this vote will then be submitted to the user identification table in the form of a controlling or identifying characteristic stored in the clearance/security field.

Thus, if the controlling information is in the clearance/security field grants full access, the user has access to all of the related information. However, if the user has been expelled or if he is not granted any access, and the user has only restricted access, then he has only limited access to that particular information.

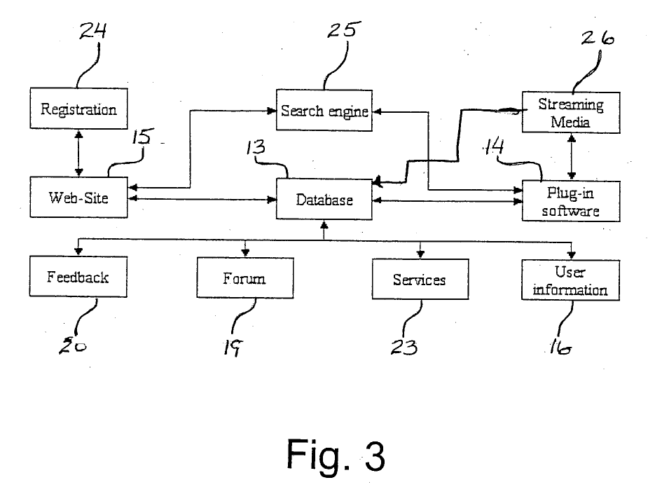

FIG. 3 shows a flow diagram of the flow of information of the services provided by the computer application. A registration module 24, which is associated with user information table 16 is in communication with web site 15 and presents a form to create new users or to allow the user's to modify their profile. A search engine 25 is in communication with web site 15 and plug-in server 14 allowing users to search central database 13. A streaming media module 26 is in communication with plug-in server 14 providing viewing or broadcasting of audio/video particularly that audio/video stored, or stored as links in table 101 in FIG. 2. Feedback table 20, forum table 19 services table 23 and user information table 16 are shown linked to database 13.

Once the plug-in has been installed, the associated user information is also pre-stored such as in the form of a cookie. Thus, once the web browser has been opened, a default user is already pre-logged in.

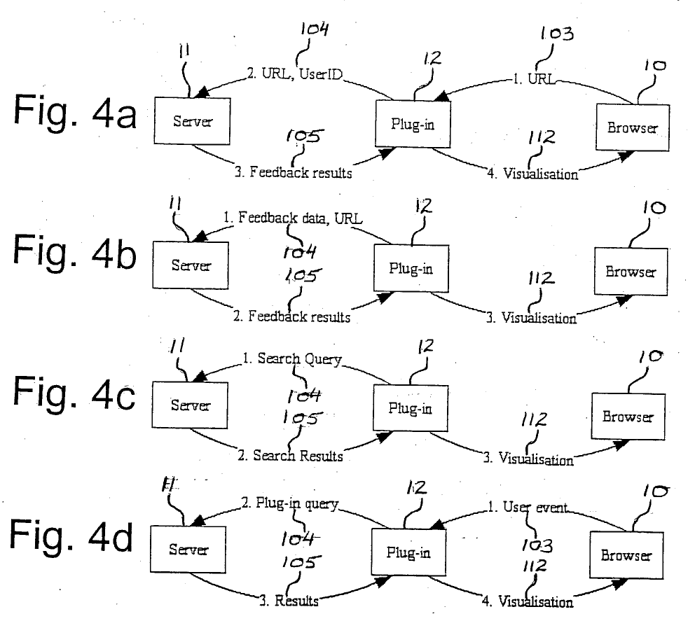

FIGS. 1 and 4a-d shows methods of communication in the computer application. Once the browser has been opened, and as shown in FIG. 1, there is a first step 101 of sending HTTP requests in the form of a URL address from web browser 10 to web server 11. This step is followed by step 102 of sending web content from web server 11 to web browser 10 (as shown in FIG. 1). When a user selects a particular website, web related or URL information is sent from browser 10 to browser plug-in 12 in step 103. Plug-in 12 then sends web related information or URL and user information to web server 11 in step 104. Web server 11 then interacts with web site 15, plug-in server 14, and central database 13 in steps 106-111 (as shown in FIG. 1). At this point, the associated URL information is stored in table 15a (FIG. 2) in the URL field.

A request is sent to plug-in server 14 in step 106 and a response is sent from plug-in server 14 in step 107. A SQL query may be sent to central database 13 in step 108 and a query result is sent from central database 13 in step 109. A request is sent to web site 15 in step 110 and an HTTP output is sent from web site 15 in step 111.

Feedback and response information is sent back from web server 11 to plug-in 12 in step 105 and a visualization is sent from plug-in 12 to web browser 10 in step 112 in the form of web page 15 (see FIG. 6B).

FIG. 4b shows a communication where feedback data is sent directly from plug-in 12 to web server 11 in step 104. This feedback data is entered by the user onto website 15 and then in through plug-in 12.

FIG. 4c shows a communication where a search query is sent directly from a user through web site 15 to plug-in 12 to web server 11 in step 104. This search query is entered by the user directly onto plug-in 12.

FIG. 4d shows a communication where a plug-in 12 recognizes a user even on browser 10 in step 103. This user event could be clicking on a link or using an internet based search engine. The activity of this user can be recorded in database 13 in table 16 in an activity field associated with the user.

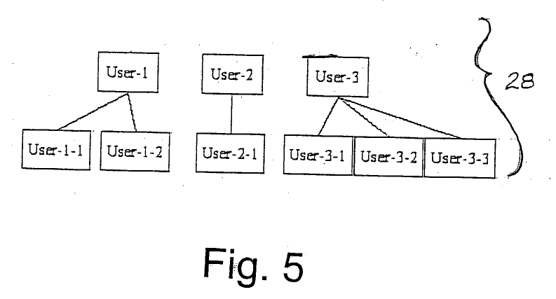

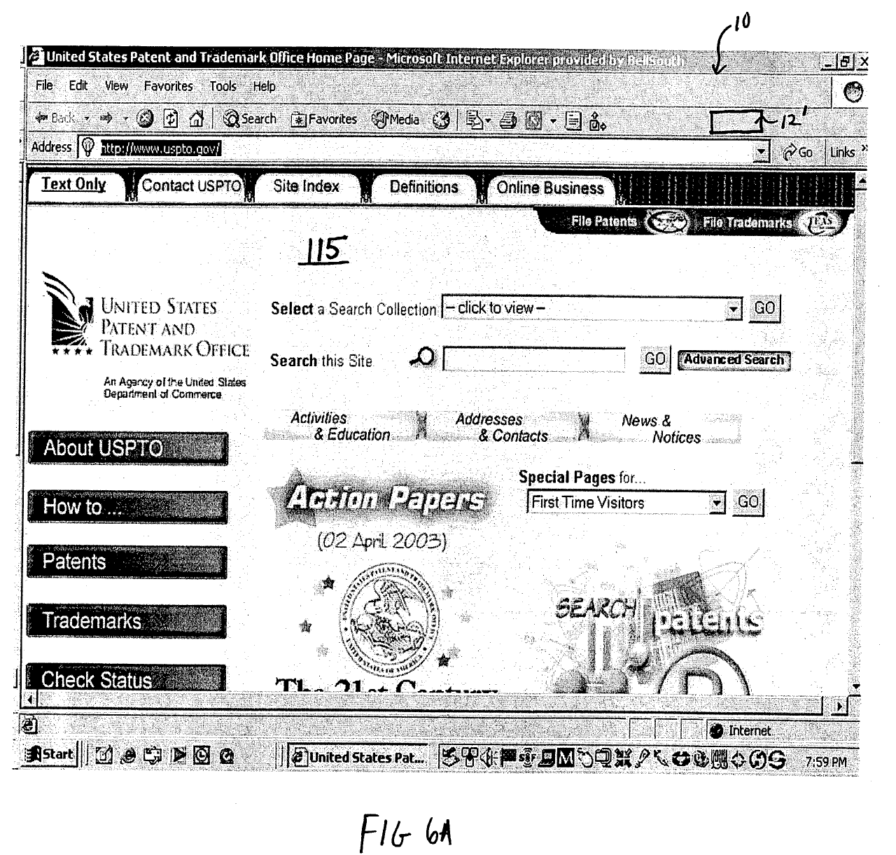

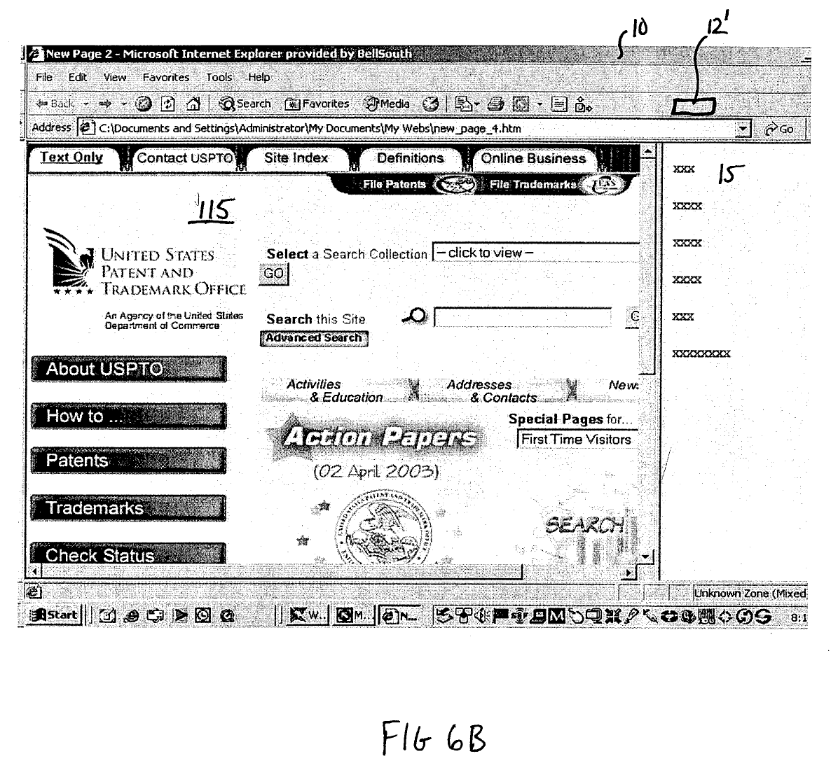

FIG. 5 shows a user tree structure 28 for database use. Wherein the organizational structure of these users is stored in table 16 as part of their compensation profile. Each user is linked to a user that referred them to the computer application. User tree 28 establishes the method of compensation. For example, if a user views media in connection with the computer application, or makes a purchase using an authorized credit card, that user is compensated as well as the referrer who is positioned higher on user tree 28 such as User-1, User-2, or User-3. However, the user is compensated a greater amount than the referrer.

FIG. 6A shows an embodiment of the computer application showing browser plug-in 12 plugged into browser 10 prior to activation of plug in 12. In addition there is shown base web page 115.

FIG. 6B shows a view of the computer application wherein once plug in 12 has been activated, such as when it has been clicked on, browser 10 expands into plug in screen 15. As stated above plug in screen can contain additional information such as additional search fields, forums for discussions, streaming media such as video or additional commercials.

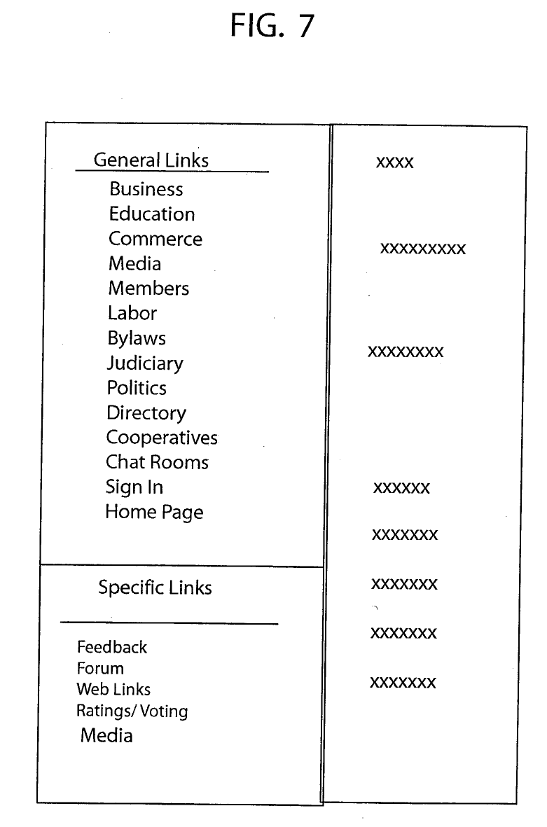

For example, FIG. 7 shows an embodiment of the invention wherein the components or web-links for additional or plug-in screen 15 are shown. These additional components are as follows: Business, education, commerce, government, media, members, labor, bylaws, judiciary, voting, feedback, directory, cooperatives, chat rooms, sign in, home page in a first section 15a while a second section can contain a static rating for the individual web page 115.

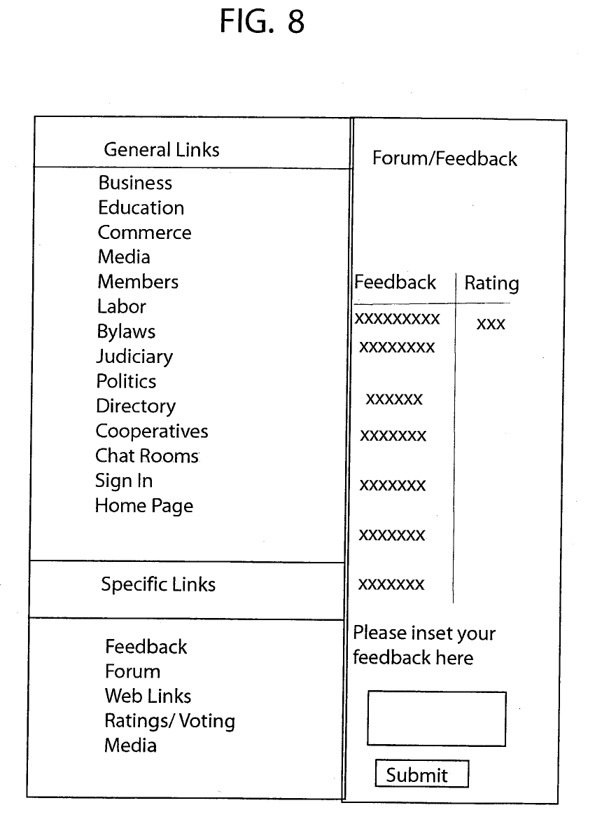

FIG. 8 shows another embodiment of the invention wherein there is shown the components of additional screen 15 such that additional screen 15 has the above cited components along with a feedback screen, wherein users can enter feedback into feedback screen and have this feedback posted. Users can then rate this feedback of the associated screen 115 such that the users ratings are calculated by the other users using the feedback screen. This forum information and rating is stored on central database 13 in table 20. With this system web page 115 has individualized feedback information stored on database server 13 and linked via tables 15b, 16, 19, 20, 22, 101, and 105 which includes id information of the logged in user and the url information of web page 115, and the information in feedback table 20 and forum table 19 which both contain the url information.

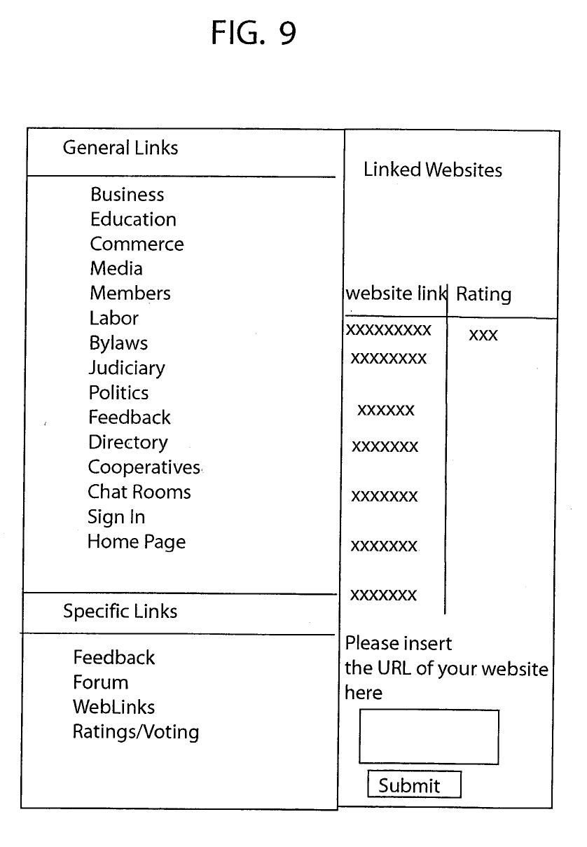

FIG. 9 shows a third embodiment of screen 15 (FIG. 6B) wherein web page information such as links can be uploaded into database server 13 stored in table 15b wherein these links are or URL addresses which are associated with original page 115. Thus when a user clicks on plug-in button 12′ different links will appear pertaining only to that associated web page 115 which is shown in web browser 10. This is accomplished by having URL information from web page 115, shown in table 15a in FIG. 2 to be linked to the URL information of table 15b of additional web page 15 such that a user can link these two web sites via a cross-correlation between information in these two tables.

The system can also offer members a credit card which is associated with the on-line community arising out of registration for the plug-in. The credit card can be used in conjunction with a central system bank that requires a participating merchant to offer a discount. The discount can for example, be 10%. Of that 10%, 30% of it goes to the central system bank as a processing fee, 63% goes to the customer, and 7% goes to the referring member. Of the 30% that goes to a central system bank, 10% is set aside for members who create content. The compensation for this content is then correlated directly to the amount of use that is ascribed to the content on a monthly basis. The compensation tallied by the users is stored in user identification table 16 and then credited to the user on a periodic basis to the user's credit card or forwarded to the user by means of a check, a wire transfer or any other means of payment.

Members can view streamed video by choosing from an array of commercials. By selecting a video, the user is informed how many commercials are necessary to view the programming. Once the commercials are selected, they are organized in the same way regular television commercials are integrated through the programming. If a program or video requires eight commercials, a viewer would be able to choose and refine a commercial advertising search for the commercials to fit the users needs. For example, if the user needs sneakers, the commercials can be geared toward a shoe company or shoe stores located within a specific distance from the user. Commercials may also be chosen randomly or from national or local advertising.

Finally, rules are established within the computer application for users. These rules are dynamic and can be changed provided ⅔ of the membership vote for change. Sanctions may be levied on members that do not follow the rules of the computer application. These sanctions can range from fine, restricted access, to expulsion.

Accordingly, while at least one embodiment of the present invention has been shown and described, it is obvious that many changes and modifications may be made thereunto without departing from the spirit and scope of the invention.

What is claimed is:

1. A multi-tier computer application that utilizes a web browser that sends HTTP requests to and receives web content from a web server, the computer application comprising:
a browser plug-in that runs simultaneously with the web browser, wherein said browser plug-in receives URL information from the web browser then sends requests and receives responses from the web server;
a central database run in communication with the web server for storing, managing, querying, and manipulating data;
a plug-in server run on the web server, wherein said plug-in server is routed URL information from a first website on the web server and begins a query to said central database relating to said URL information of said first website and then sends the result back through the web server to said browser plug-in; and
a second web site run on the web server, in association with said first website, wherein said second web site can register a user, change a user profile and broadcast media.

2. The computer application of claim 1, wherein said central database comprises registration and user information tables, membership information tables, member profile tables, directories of services tables, forum tables, and feedback tables, and wherein each of said tables are in communication with one another.

3. The computer application of claim 2, wherein said user information table comprises an id, a username a password, a referrer name, and an address.

4. The computer application of claim 2, wherein each user information table has at least one member profile table comprising an id, a user id, a property id, and a value.

5. The computer application of claim 4, wherein every member profile table has a property table comprising, an id, a name, a type, a group name, and a group id.

6. The computer application of claim 2, wherein each user information table has at least one forum table comprising an id, a forum id, a time stamp, a user id, and a comment.

7. The computer application of claim 6, wherein every forum table has a forum topic table comprising an id, a name, a parent, and a type.

8. The computer application of claim 2, wherein each user information table has at least one feedback table comprising an id, a URL address, a value, a timestamp and a user id, wherein said feedback table permits users to send feedback regarding a URL and said browser plug-in to display other users feedback regarding that URL address.

9. The computer application of claim 2, wherein each user information table has at least one user services table comprising an id, a user id, and a service id.

10. The computer application of claim 9, wherein every user services table has a services table comprising an id and a service name.

11. The computer application of claim 1, further comprising a registration module in communication with said web site, wherein said registration module creates new users and modifies a users profile.

12. The computer application of claim 1, further comprising a search engine in communication with said second web site and said plug-in server, wherein said search engine allows a user to search all of said central database.

13. The computer application of claim 1, further comprising a streaming media module in communication with said plug-in server, wherein said streaming media module provides view or broadcasting of audio/video in either of said first or said second website on the web browser.

14. A method of operating a computer application having a plug-in operating with a web browser, and a web site, a plug-in server and a central database operating with a web server, method of operating comprising the following steps:
sending HTTP requests from the web browser to the web server;
sending web content from the web server to the web browser in response to said HTTP requests;
sending web related information and user information as a request from the browser plug-in to the web server;
routing said web related information and said user information through the web server to the plug-in server;
querying for feedback in the plug-in server and the central database relating to said request;
transmitting feedback results from the plug-in server through the web server to the browser plug-in; and
transmitting a visualization from the browser plug-in to the web browser.

15. The method of operating a computer application of claim 14, further comprising the step of:
sending URL information from the web browser to the browser plug-in;
wherein said step of sending web related information comprises sending URL information to the web server;
wherein said step of routing web related information comprises routing URL information including an IP/Host name to the plug-in server; and
wherein said step of querying for feedback comprising querying for feedback relating to said IP/host name.

16. A method of operating a computer application of claim 14, wherein:
said step of sending web related information comprises sending feedback data and a URL from the browser plug-in to the web server; and
said step of routing said web related information comprises routing feedback data and URL information including IP/host name through the web server to the plug-in server.

17. The method of operating a computer application of claim 14, wherein:
said step of sending web related information comprises sending a search query from the browser plug-in to the web server; and
said step of querying for feedback in the plug-in server and central database comprises searching the central database relating to said search query from the browser plug-in; and

18. The method of operating a computer application of claim 14, further comprising the step of:
performing a user event on the web browser, recognized by the browser plug-in;
wherein said step of sending web related information comprises sending a browser plug-in query from the browser plug-in to the web server.

19. The method of operating a computer application of claim 18, wherein said step of performing a user event involves performing a search on an internet search engine.

20. The method of operating a computer application of claim 18, wherein said step of performing a user event involves selecting a link on a web page.

21. The method of operating a computer application of claim 14, further comprising the following steps:
registering as a user to use the computer application; and
linking a newly registered user to another user or a referrer, if said referrer referred said newly registered user to the computer application.

22. The method of operating a computer application of claim 21, further comprising the following steps:
selecting a media file to play;
selecting commercials to be played while playing said media; and
playing commercials and media files for said member.

23. The method of operating a computer application of claim 22, wherein said step of selecting commercials to be played comprises searching and selecting commercials based on a members needs and defined properties.

24. The method of operating a computer application of claim 21, further comprising the following step:
compensating said newly registered user and said referrer when said newly registered user makes a purchase in connection with the computer application, wherein compensation for said newly registered user is greater than compensation for said referrer.

25. The method of operating a computer application of claim 21, wherein said step of registering as a new user comprises:
creating a main profile comprising name and address;
adding properties to said main profile, wherein said properties are chosen from a list of properties.
